(19) United States
(12) Patent Application Publication
(10) Pub. No.: US 2025/0054944 A1
(43) Pub. Date: Feb. 13, 2025

(54) NEGATIVE ELECTRODE AND SECONDARY BATTERY

(71) Applicant: MURATA MANUFACTURING CO., LTD., Kyoto (JP)

(72) Inventor: Yuichi SANO, Kyoto (JP)

(21) Appl. No.: 18/933,129

(22) Filed: Oct. 31, 2024

Related U.S. Application Data
(63) Continuation of application No. PCT/JP2023/021741, filed on Jun. 12, 2023.

(30) Foreign Application Priority Data
Jul. 28, 2022 (JP) 2022-120791

(51) Int. Cl. H01M 4/134; H01M 4/02; H01M 4/38; H01M 4/66

(52) U.S. Cl. CPC H01M 4/134; H01M 4/386; H01M 4/661; H01M 2004/027

(57) ABSTRACT

A negative electrode and a secondary battery capable of improving cycle characteristics are provided. The negative electrode includes a negative electrode current collector, a negative electrode active material layer, a first layer provided between the negative electrode current collector and the negative electrode active material layer, and a second layer provided on the negative electrode active material layer. The negative electrode current collector contains at least one or more of copper, nickel, and iron, the negative electrode active material layer contains silicon, the first layer contains silicon, a metal element constituting the negative electrode current collector, and at least one or more of titanium, nickel, zinc, silver, iron, boron, indium, and germanium, and the second layer contains silicon and at least one or more of titanium, nickel, zinc, silver, iron, boron, indium, and germanium.

### CROSS REFERENCE TO RELATED APPLICATIONS

The present application is a continuation of PCT patent application no. PCT/JP2023/021741, filed on Jun. 12, 2023, which claims priority to Japanese patent application no. 2022-120791, filed on Jul. 28, 2022, the entire contents of which are incorporated herein by reference.

### BACKGROUND

The present disclosure relates to a negative electrode and a secondary battery.

Silicon may be used as a main component in a negative electrode active material of a lithium ion secondary battery.

### SUMMARY

The present disclosure relates to a negative electrode and a secondary battery.

When silicon is used as a main component in a negative electrode active material of a lithium ion secondary battery, it is known that silicon expands by absorbing lithium ions at the time of initial charge and discharge. The expansion may cause cracks in the negative electrode active material layer and peeling between the negative electrode active material layer and the negative electrode current collector, as a result of which the cycle characteristics may be deteriorated.

The present disclosure, in an embodiment, relates to a negative electrode and a secondary battery capable of improving cycle characteristics.

A negative electrode according to one aspect includes a negative electrode current collector, a negative electrode active material layer, a first layer provided between the negative electrode current collector and the negative electrode active material layer, and a second layer provided on the negative electrode active material layer, in which the negative electrode current collector contains at least one or more of copper, nickel, and iron, the negative electrode active material layer contains silicon, the first layer contains silicon, a metal element constituting the negative electrode current collector, and at least one or more of titanium, nickel, zinc, silver, iron, boron, indium, and germanium, and the second layer contains silicon and at least one or more of titanium, nickel, zinc, silver, iron, boron, indium, and germanium.

A secondary battery according to one aspect includes the negative electrode, a positive electrode, and an electrolyte.

The present technology can improve cycle characteristics according to an embodiment.

### BRIEF DESCRIPTION OF THE FIGURES

FIG. 1 is a schematic sectional view illustrating an example of a secondary battery according to an embodiment.

FIG. 2 is a schematic sectional view illustrating an example of a secondary battery according to an embodiment.

FIG. 3 is a schematic sectional view illustrating an example of a secondary battery according to an embodiment.

FIG. 4 is a schematic enlarged view of a region A in FIG. 3.

FIG. 5 is a schematic cutaway view illustrating an example of a secondary battery according to an embodiment.

FIG. 6 is a schematic sectional view taken along line VI-VI in FIG. 5.

### DETAILED DESCRIPTION

The present disclosure will be described in further detail according to an embodiment.

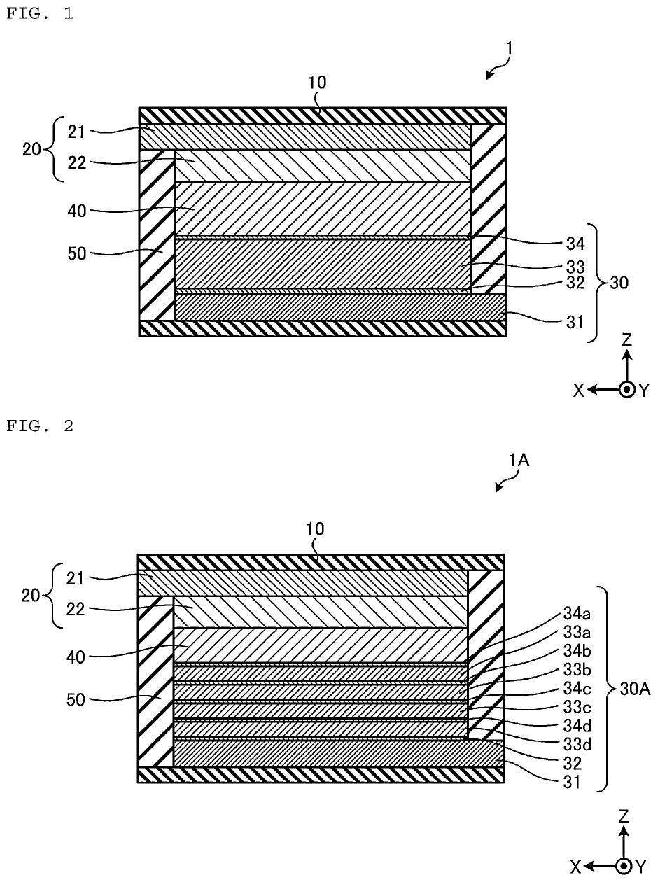

FIG. 1 is a schematic sectional view illustrating an example of a secondary battery according to a first embodiment. The secondary battery 1 in the first embodiment is an all-solid-state battery in which an electrolyte is solid, and is a lithium ion secondary battery. As illustrated in FIG. 1, the secondary battery 1 includes a protective layer 10, a positive electrode 20, a negative electrode 30, a solid-state electrolyte layer 40, and an insulating layer 50. In the example of FIG. 1, the secondary battery 1 has a structure in which a sheet-like positive electrode 20, a negative electrode 30, and a solid-state electrolyte layer 40 are stacked.

In the drawings illustrating the present embodiment, the Z direction refers to a stacking direction of the positive electrode 20, the negative electrode 30, and the solid-state electrolyte layer 40, the X direction refers to a direction orthogonal to the Z direction and parallel to the section of FIG. 1, and the Y direction refers to a direction orthogonal to the X direction and the Z direction. In the description of the present embodiment, one of the X directions may be described as the +X direction, and the other may be described as the −X direction. Similarly, in the Z direction, one direction may be described as the +Z direction and the other direction may be described as the −Z direction.

The protective layer 10 is a layer provided to physically and chemically protect the secondary battery 1. The protective layer 10 is provided so as to overlap the stack of the positive electrode 20, the negative electrode 30, and the solid-state electrolyte layer 40, in plan view in the Z direction, and is provided on both sides in the Z direction of the stack of the positive electrode 20, the negative electrode 30, and the solid-state electrolyte layer 40 in the example of FIG. 1. The material of the protective layer 10 is not particularly limited as long as it has insulating properties, and is, for example, resin, glass, or ceramics.

The positive electrode 20 includes a positive electrode current collector layer 21 and a positive electrode active material layer 22. In the example of FIG. 1, the positive electrode 20 has a structure in which the positive electrode active material layer 22 is stacked in the −Z direction of the positive electrode current collector layer 21, but this is merely an example, and the positive electrode active material layer 22 may be stacked in the +Z direction of the positive electrode current collector layer 21.

The positive electrode current collector layer 21 is a layer having conductivity. In the example of FIG. 1, the positive electrode current collector layer 21 has an exposed end surface in the +X direction, and can be connected to the outside. That is, the end surface of the positive electrode current collector layer 21 in the +X direction is a plus electrode of the secondary battery 1. The material of the positive electrode current collector layer 21 is not particularly limited as long as it has conductivity, and examples thereof include metal materials such as silver, palladium, gold, platinum, aluminum, copper, and nickel, and carbon materials.

The positive electrode active material layer 22 is a layer containing a positive electrode active material. The positive electrode active material layer 22 is stacked on the positive electrode current collector layer 21. The positive electrode active material is not particularly limited, and examples thereof include at least one selected from the group consisting of a lithium-containing phosphate compound having a NASICON-type structure, a lithium-containing phosphate compound having an olivine-type structure, a lithium-containing layered oxide, a lithium-containing oxide having a spinel-type structure, and the like. Examples of the lithium-containing phosphate compound having a NASICON-type structure include Li₃V₂(PO₄)₃. Examples of the lithium-containing phosphate compound having an olivine-type structure include Li₃Fe₂(PO₄)₃ and LiMnPO₄. Examples of the lithium-containing layered oxide include LiCoO₂ and LiCo_{1/3}Ni_{1/3}Mn_{1/3}O₂. Examples of the lithium-containing oxide having a spinel-type structure include LiMn₂O₄ and LiNi_{0.5}Mn_{1.5}O₄.

The material contained in the positive electrode active material layer 22 is not limited to the positive electrode active material, and may contain a solid-state electrolyte or a sintering additive described later. The sintering additive is not particularly limited, and examples thereof include lithium oxide, sodium oxide, potassium oxide, boron oxide, silicon oxide, bismuth oxide, and phosphorus oxide.

The negative electrode 30 includes a negative electrode current collector layer 31, an anti-peeling layer 32, a negative electrode active material layer 33, and a cap layer 34.

The negative electrode current collector layer 31 is a layer having conductivity. Here, the negative electrode current collector layer 31 is an example of the “negative electrode current collector”. In the example of FIG. 1, the negative electrode current collector layer 31 has an exposed end surface in the −X direction, and can be connected to the outside. That is, the end surface of the negative electrode current collector layer 31 in the −X direction is a minus electrode of the secondary battery 1. In the example of FIG. 1, the thickness of the negative electrode current collector layer 31 is not particularly limited, but is preferably thicker than the negative electrode active material layer 33 described later, and is approximately 30 μm. The material of the negative electrode current collector layer 31 is a conductive metal and contains at least one or more metals of copper, nickel, and iron. The material of the negative electrode current collector layer 31 is not limited thereto, and may further contain, for example, a metal material such as palladium, gold, platinum, or aluminum. The negative electrode current collector layer 31 is not limited to one layer, and may include a plurality of layers such as stainless steel in which the anti-peeling layer 32 side is coated with nickel. In the following description, the material constituting the negative electrode current collector layer 31 may be described as “negative electrode current collector material”.

The anti-peeling layer 32 is a layer provided on the negative electrode current collector layer 31. The anti-peeling layer 32 is provided between the negative electrode current collector layer 31 and the negative electrode active material layer 33. Here, the anti-peeling layer 32 is an example of the “first layer”. The anti-peeling layer 32 has a thickness of 5 nm or more and 55 nm or less. In the example of FIG. 1, the anti-peeling layer 32 is provided in the +Z direction of the negative electrode current collector layer 31.

The anti-peeling layer 32 contains silicon, a negative electrode current collector material, and at least one or more of titanium (Ti), nickel (Ni), zinc (Zn), silver (Ag), iron (Fe), boron (B), indium (In), and germanium (Ge). This allows the anti-peeling layer 32 to suppress peeling between the negative electrode current collector layer 31 and the negative electrode active material layer 33 when the negative electrode active material layer 33 expands. As a result, the cycle characteristics of the secondary battery 1 can be improved. Here, the element constituting the anti-peeling layer 32 excluding silicon and the negative electrode current collector material is preferably titanium. In this case, the resistance of the anti-peeling layer 32 can be reduced. In the following description, the element constituting the anti-peeling layer 32 excluding silicon and the negative electrode current collector material may be described as “first metal”.

The anti-peeling layer 32 contains silicon on the negative electrode active material layer 33 side. That is, silicon and the first metal are co-present on the negative electrode active material layer 33 side of the anti-peeling layer 32. Here, the concentration of silicon in the anti-peeling layer 32 can be measured by a method for composition analysis in a depth direction such as X-ray photoelectron spectroscopy (XPS), Auger electron spectroscopy (AES), or secondary ion mass spectrometry (SIMS). This allows the anti-peeling layer 32 to suppress interface energy between the anti-peeling layer 32 and the negative electrode active material layer 33, and to further reduce resistance between the negative electrode current collector layer 31 and the negative electrode active material layer 33. The anti-peeling layer 32 does not contain silicon on the negative electrode current collector layer 31 side. That is, it can be said that the anti-peeling layer 32 is a layer in which silicon is diffused only in a portion in contact with the negative electrode active material layer 33 in the thickness direction. Thus, it can be said that the concentration of silicon contained on the negative electrode active material layer 33 side of the anti-peeling layer 32 is higher than the concentration of silicon contained on the negative electrode current collector layer 31 side of the anti-peeling layer 32.

The anti-peeling layer 32 contains the negative electrode current collector material on the negative electrode current collector layer 31 side. That is, the negative electrode current collector material and the first metal are co-present on the negative electrode current collector layer 31 side of the anti-peeling layer 32. Here, the concentration of the negative electrode current collector material of the anti-peeling layer 32 can be measured by a method for composition analysis in a depth direction such as XPS, AES, or SIMS. This allows the anti-peeling layer 32 to suppress interface energy between the anti-peeling layer 32 and the negative electrode current collector layer 31, and to further reduce resistance between the negative electrode current collector layer 31 and the negative electrode active material layer 33. The anti-peeling layer 32 does not contain the negative electrode current collector material on the negative electrode active material layer 33 side. That is, it can be said that the anti-peeling layer 32 is a layer in which the negative electrode current collector material is diffused only in a portion in contact with the negative electrode current collector layer 31 in the thickness direction. Thus, it can be said that the concentration of the negative electrode current collector material contained on the negative electrode current collector layer 31 side of the anti-peeling layer 32 is higher than the concentration of the negative electrode current collector material contained on the negative electrode active material layer 33 side of the anti-peeling layer 32.

The negative electrode active material layer 33 is a layer containing a negative electrode active material. In the example of FIG. 1, the negative electrode active material layer 33 is provided in the +Z direction of the anti-peeling layer 32. The thickness of the negative electrode active material layer 33 is 2 μm or more and 5 μm or less. This allows an increase in the capacity of the secondary battery 1.

The negative electrode active material layer 33 contains silicon as a negative electrode active material. The crystallinity of silicon is not particularly limited, and may be, for example, amorphous. The negative electrode active material is preferably doped silicon. As the dopant element of silicon which is the negative electrode active material, at least one or more elements of boron, phosphorus (P), aluminum, bismuth (Bi), lithium (Li), and oxygen (O) can be used. This allows suppression of a decrease in the capacity of the secondary battery 1 due to dopants.

The cap layer 34 is a layer provided on the negative electrode active material layer 33. Here, the cap layer 34 is an example of the “second layer”. In the example of FIG. 1, the cap layer 34 is provided in the +Z direction of the negative electrode active material layer 33. The cap layer 34 has a thickness of 5 nm or more and 55 nm or less.

The cap layer 34 contains silicon and at least one or more of titanium (Ti), nickel (Ni), zinc (Zn), silver (Ag), iron (Fe), boron (B), indium (In), and germanium (Ge). This allows the cap layer 34 to have malleability. In a case also where the thickness of the negative electrode active material layer 33 is 2 μm or more, the stress generated by the expansion of the negative electrode active material layer 33 is applied to the cap layer 34 which is less likely to be cracked because of having malleability, so that the generation of cracks in the negative electrode active material layer 33 can be suppressed. Thus, damage to the negative electrode active material layer 33 can be suppressed, as a result of which the cycle characteristics of the secondary battery 1 can be improved. When the negative electrode active material layer 33 expands, the cap layer 34 is deformed so as to be pressed against the solid-state electrolyte layer 40, whereby the cap layer 34 and the solid-state electrolyte layer 40 are brought into close contact with each other, and interface resistance between the cap layer 34 and the solid-state electrolyte layer 40 can be reduced. Here, the element constituting the cap layer 34 excluding silicon is preferably titanium. This allows reduction of the resistance of the cap layer 34. In addition, the element constituting the cap layer 34 excluding silicon are preferably the same as the element constituting the anti-peeling layer 32 excluding silicon and the negative electrode current collector material. This allows uniform relaxation of the stress of the negative electrode 30. In the following description, the element constituting the cap layer 34 excluding silicon may be described as “second metal”.

The cap layer 34 contains silicon throughout the thickness direction. This allows the cap layer 34 to further reduce interface resistance between the cap layer 34 and the solid-state electrolyte layer 40. The concentration of the second metal in the cap layer 34 is preferably lower toward the negative electrode active material layer 33. That is, it is preferable that the cap layer 34 has a concentration gradient of silicon in the thickness direction, and the closer to the negative electrode active material layer 33, the higher the concentration of silicon. Here, the concentration of silicon in the cap layer 34 can be measured by composition analysis in a depth direction such as XPS, AES, or SIMS. When the cap layer 34 has a concentration gradient, since in the cap layer 34, the stress of the layer continuously changes in the Z direction, the occurrence of cracks due to the stress of the negative electrode active material layer 33 can be further suppressed. In addition, since the concentration of the second metal continuously changes in the direction of the negative electrode active material layer 33, interface energy between the cap layer 34 and the negative electrode active material layer 33 can be suppressed, and interface resistance between the cap layer 34 and the negative electrode active material layer 33 can be reduced. The concentration of silicon in the cap layer 34 is not limited to having a gradient in the thickness direction, and may be uniform.

The configuration of the negative electrode 30 is not limited to the above. In the example of FIG. 1, the negative electrode 30 has a structure in which the anti-peeling layer 32, the negative electrode active material layer 33, and the cap layer 34 are stacked in the +Z direction of the negative electrode current collector layer 31, but this is merely an example, and the layers may be stacked in the −Z direction of the negative electrode current collector layer 31.

The solid-state electrolyte layer 40 is a layer provided between the positive electrode 20 and the negative electrode 30. The solid-state electrolyte layer 40 is a sintered body containing a solid-state electrolyte. The material of the solid-state electrolyte is not particularly limited as long as ions can move between the positive electrode 20 and the negative electrode 30. Examples of the material of the solid-state electrolyte include a lithium-containing phosphate compound having a NASICON structure, an oxide having a perovskite structure, and an oxide having a garnet-type structure or a structure similar to a garnet-type structure. Examples of the lithium-containing phosphate compound having a NASICON structure include LiₓM_{y}(PO₄)₃ (1≤x≤2, 1≤y≤2, M is at least one of Ti, Ge, Al, Ga, and Zr). An example of the lithium-containing phosphate compound having a NASICON structure is Li_{1.2}Al_{0.2}Ti_{1.8}(PO₄)₃. An example of the oxide having a perovskite structure is La_{0.55}Li_{0.35}TiO₃. An example of the oxide having a garnet-type structure or a structure similar to a garnet-type structure is Li₇La₃Zr₂O₁₂. The material of the solid-state electrolyte layer 40 is not limited to the solid-state electrolyte, and may contain the above-described sintering additive.

The side surface reinforcing portion 60 is provided to prevent a short circuit of the secondary battery 1. In the example of FIG. 1, the side surface reinforcing portion 60 is provided on end surfaces in the X direction and the Y direction of the positive electrode 20, the negative electrode 30, and the solid-state electrolyte layer 40. The material of the side surface reinforcing portion 60 is not particularly limited as long as it is an insulating material, and is, for example, resin, glass, or ceramics.

As described above, the negative electrode 30 according to the present embodiment includes the negative electrode current collector (negative electrode current collector layer 31), the negative electrode active material layer 33, the first layer (anti-peeling layer 32) provided between the negative electrode current collector and the negative electrode active material layer 33, and the second layer (cap layer 34) provided on the negative electrode active material layer 33, in which the negative electrode current collector contains a negative electrode current collector material that is at least one or more metals of copper, nickel, and iron, the negative electrode active material layer 33 contains silicon, the first layer contains silicon, a metal element constituting the negative electrode current collector, and at least one or more of titanium, nickel, zinc, silver, iron, boron, indium, and germanium, and the second layer contains silicon and at least one or more of titanium, nickel, zinc, silver, iron, boron, indium, and germanium.

Thus, in a case where the negative electrode active material layer 33 expands, the occurrence of cracks in the negative electrode active material layer 33 can be suppressed by the second layer, and peeling between the negative electrode current collector and the negative electrode active material layer 33 can be suppressed by the first layer, so that the cycle retention rate can be improved.

In an embodiment, the element constituting the first layer excluding silicon and the metal constituting the negative electrode current collector are the same as the element constituting the second layer excluding silicon. This allows uniform relaxation of the stress of the negative electrode 30.

In an embodiment, the element constituting the first layer excluding silicon and the metal constituting the negative electrode current collector is titanium, and the element constituting the second layer excluding silicon is titanium. This allows reduction of the resistance of the first layer and the second layer.

In an embodiment, the concentration of silicon contained on the negative electrode active material layer side of the first layer is higher than the concentration of silicon contained on the negative electrode current collector side of the first layer, the concentration of the negative electrode current collector material contained on the negative electrode current collector side of the first layer is higher than the concentration of the negative electrode current collector material contained on the negative electrode active material layer 33 side of the first layer, and the second layer contains silicon throughout the thickness direction. As a result, the interface energy between the cap layer 34 and the negative electrode active material layer 33 can be further suppressed, and the interface resistance between the second layer and the negative electrode active material layer 33 can be further reduced. Since in the first layer, the concentration of silicon continuously changes in the direction in which the negative electrode active material layer 33 is provided, interface energy between the first layer and the negative electrode active material layer 33 can be further suppressed, and resistance between the negative electrode current collector and the negative electrode active material layer 33 can be further reduced. Since in the first layer, the concentration of the negative electrode current collector material is continuously changed in the direction in which the negative electrode current collector is provided, the interface energy between the first layer and the negative electrode current collector can be further suppressed, and the resistance between the negative electrode current collector and the negative electrode active material layer 33 can be further reduced.

The secondary battery 1 according to the present embodiment includes a positive electrode 20, a negative electrode 30, and an electrolyte (solid-state electrolyte layer 40). With this configuration, the cycle retention rate can be improved.

The negative electrode 30 according to the present embodiment is produced, for example, by the following method.

First, as a stacking step, the first metal layer, the silicon-containing layer, and the second metal layer are stacked in this order on the negative electrode current collector layer 31. The stacking step is performed so as not to come into contact with air, and stacking is performed, for example, by a method such as sputtering, chemical vapor deposition, or ion plating. The first metal layer is a layer made of the first metal, and has a thickness of 0.1 μm or more and 1 μm or less. Here, the second metal layer is a layer made of the second metal, and has a thickness of 0.1 μm or more and 1 μm or less. The silicon-containing layer is a layer made of a material containing silicon, and is, for example, a layer of a mixture of silicon and a dopant. In this case, silicon and the dopant are mixed by simultaneously stacking them on the first metal layer.

Next, the stack including the negative electrode current collector layer 31 is annealed. By annealing, the silicon-containing layer becomes doped silicon, the first metal of the first metal layer becomes the anti-peeling layer 32, and the second metal of the second metal layer diffuses into the silicon-containing layer to form the cap layer 34. The annealing conditions are adjusted such that silicon is contained throughout the thickness direction of the cap layer 34. Here, a portion of the silicon-containing layer in which neither the first metal nor the second metal has diffused becomes the negative electrode active material layer 33.

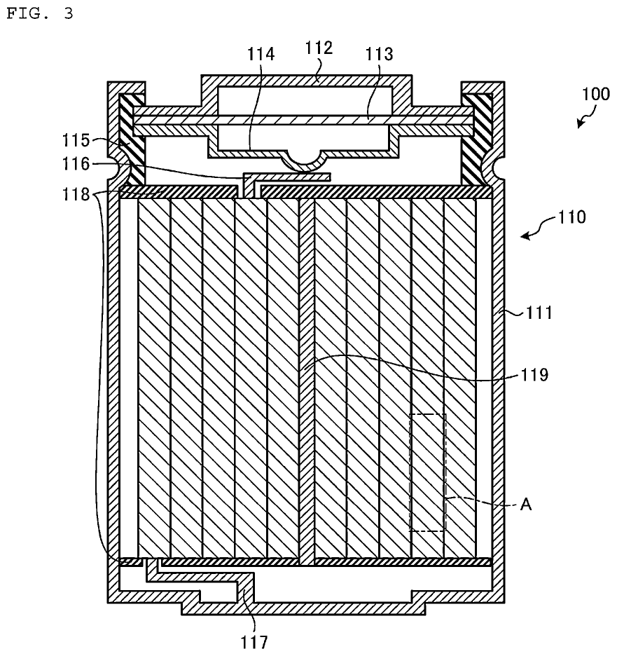

FIG. 2 is a schematic sectional view illustrating an example of a secondary battery according to a second embodiment. Hereinafter, the secondary battery according to the present embodiment will be described. The same components are denoted by the same reference symbols, and the description thereof will be omitted. A secondary battery 1A according to the second embodiment is different from the secondary battery 1 according to the first embodiment in that a negative electrode 30A includes a plurality of negative electrode active material layers 33a to 33d and a plurality of cap layers 34a to 34d. Here, the cap layers 34a to 34d are an example of the “second layer”. In the plurality of negative electrode active material layers 33a to 33d, the thickness of each of the plurality of cap layers 34a to 34d is smaller than the thickness of the anti-peeling layer 32.

As illustrated in FIG. 2, in the secondary battery 1A according to the second embodiment, the negative electrode active material layers 33a to 33d and the cap layers 34a to 34d are stacked in the +Z direction of the anti-peeling layer 32 in the order of the negative electrode active material layer 33d, the cap layer 34d, the negative electrode active material layer 33c, the cap layer 34c, the negative electrode active material layer 33b, the cap layer 34b, the negative electrode active material layer 33a, and the cap layer 34a. That is, in the secondary battery 1A, it can be said that the cap layers 34a to 34d are alternately stacked with the negative electrode active material layers 33a to 33d in the Z direction.

With this structure, the cap layers 34b to 34d can suppress peeling between the negative electrode active material layers 33a to 33d, so that the cycle characteristics of the secondary battery 1A can be improved. In addition, since the second metal contained in the cap layers 34b to 34d acts as a surfactant (surface active agent) of the silicon-containing layer in the production of the negative electrode 30A, the silicon-containing layer is thickened. As a result, the capacity of the secondary battery 1 can be increased. More specifically, in the production of the negative electrode 30A, by stacking the second metal layer on the silicon-containing layer, the surface energy of the first silicon-containing layer is reduced, and thickening of the second silicon-containing layer stacked on the second metal layer is promoted.

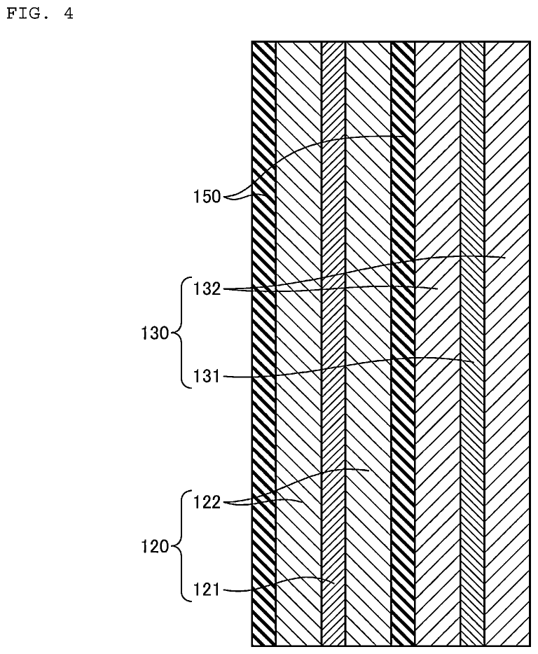

FIG. 3 is a schematic sectional view illustrating an example of a secondary battery according to a third embodiment. The secondary battery 100 according to the third embodiment is a cylindrical battery and includes a liquid electrolyte. As illustrated in FIG. 3, the secondary battery 100 includes a casing 110, a positive electrode 120, a negative electrode 130, and a separator 150. The casing 110 is a case that houses an electrode assembly and an electrolyte solution (not shown) therein. The casing 110 includes a battery can 111, a lid 112, a heat sensitive resistance element 113, a safety valve mechanism 114, a gasket 115, a positive electrode lead 116, a negative electrode lead 117, a center pin 119, and an insulating plate 118.

The battery can 111 is a cylindrical member including an end surface serving as a minus electrode of the secondary battery 100. That is, the battery can 111 is a cylinder in which one end surface is closed and the other end surface is opened. The battery can 111 is a conductor. For example, the surface of an iron (Fe) substrate is plated with nickel (Ni).

The lid 112 is a disk-shaped member including a protrusion serving as a plus electrode of the secondary battery 100. The lid 112 is provided on the end surface on the opened side of the battery can 111. The lid 112 is made of metal, for example, the same material as the battery can 111.

Here, in the description of the present embodiment, the direction in which the cylindrical portion of the battery can 111 extends may be described as the length direction of the secondary battery 100. The plus electrode of the secondary battery 100 refers to the protrusion of the lid 112, and the minus electrode of the secondary battery 100 refers to the closed end surface of the battery can 111.

The heat sensitive resistance element 113 is an element whose resistance increases with an increase in temperature. The heat sensitive resistance element 113 is provided on the minus electrode side relative to the lid 112. When the secondary battery 100 becomes high temperature due to a short circuit or the like, the heat sensitive resistance element 113 has an increased resistance value and limits the current.

The safety valve mechanism 114 is a mechanism whose shape changes according to the gas pressure in the casing 110. The safety valve mechanism 114 is provided on the minus electrode side relative to the heat sensitive resistance element 113. The safety valve mechanism 114 is electrically connected to the lid 112 via the heat sensitive resistance element 113. The safety valve mechanism 114 has a protrusion on the minus electrode side. When the gas pressure in the casing 110 is normal, the safety valve mechanism is in contact with the positive electrode lead 116 via the protrusion and is electrically connected. On the other hand, when the gas pressure in the casing 110 increases, the protrusion of the safety valve mechanism 114 is reversed to the plus electrode side and separated from the positive electrode lead 116, whereby the positive electrode lead 116 and the lid 112 are electrically disconnected from each other.

The gasket 115 is an annular member that fixes the lid 112, the heat sensitive resistance element 113, and the safety valve mechanism 114 to the battery can 111. The gasket 115 is provided on the open end surface of the battery can 111. The gasket 115 brings the battery can 111 and the lid 112 into close contact with each other to make the inside of the casing 110 airtight. The gasket 115 is an insulator.

The positive electrode lead 116 is a terminal connected to a positive electrode 120 of an electrode assembly described later. The positive electrode lead 116 is electrically connected to the lid 112 via the safety valve mechanism 114 and the heat sensitive resistance element 113. The positive electrode lead 116 is a conductor, and is, for example, aluminum (Al).

The negative electrode lead 117 is a terminal connected to a negative electrode 130 of an electrode assembly described later. The negative electrode lead 117 is electrically connected to the battery can 111. The negative electrode lead 117 is a conductor, and is, for example, nickel (Ni).

The insulating plate 118 is a plate-like member which is an insulator. Two insulating plates 118 are provided so as to cover the section of the electrode assembly described later on the plus electrode side of the secondary battery 100 and the section of the electrode assembly on the minus electrode side of the secondary battery 100.

The center pin 119 is provided on the center axis of the electrode assembly. The center pin 119 is a linear member having a length in the length direction of the secondary battery 100. The material of the center pin 119 is not particularly limited, and is, for example, metal.

FIG. 4 is an enlarged view of the region A in FIG. 3. As illustrated in FIGS. 3 and 4, the positive electrode 120 and the negative electrode 130 according to the third embodiment are stacked with the separator 150 interposed therebetween, and are provided inside the battery can 111. In the example of FIG. 3, the positive electrode 120, the negative electrode 130, and the separator 150 are stacked in the radial direction of the secondary battery 100 with the center pin 119 as the center.

The positive electrode 120 includes a positive electrode current collector layer 121 and a positive electrode active material layer 122. In the positive electrode 120, the positive electrode current collector layer 121 is stacked between two positive electrode active material layers 122. The material and thickness of the positive electrode current collector layer 121 are the same as those of the positive electrode current collector layer 21 in the first embodiment. The material and thickness of the positive electrode active material layer 122 are the same as those of the positive electrode active material layer 22 in the first embodiment.

The negative electrode 130 includes a negative electrode current collector layer 131 and a negative electrode material layer 132. Here, the negative electrode current collector layer 131 is an example of the “negative electrode current collector”. In the negative electrode 130, the negative electrode current collector layer 131 is stacked between two negative electrode material layers 132. The negative electrode current collector layer 131 is made of the same material as the negative electrode current collector layer 31 in the first embodiment. The negative electrode material layer 132 is a layer including a negative electrode active material layer. The negative electrode material layer 132 includes an anti-peeling layer, a negative electrode active material layer, and a cap layer which are made of the same materials as those of the first embodiment. That is, the anti-peeling layer is an example of the “first layer”, and the cap layer is an example of the “second layer”. Here, the cap layer is a layer thinner than the anti-peeling layer. The negative electrode material layer 132 is a stack in which an anti-peeling layer, a negative electrode active material layer, and a cap layer are stacked in this order from the negative electrode current collector layer 131 side. Thus, in a case where the negative electrode active material layer expands, since the anti-peeling layer is provided, it is possible to suppress peeling of the negative electrode material layer 132 from the negative electrode current collector layer 131. Also, in a case where the negative electrode active material layer is cracked due to expansion, since the cap layer is provided, it is possible to suppress deterioration of the negative electrode active material due to film formation on a new surface in the crack by entry of the electrolyte solution into the crack. As a result, the cycle characteristics of the secondary battery 100 can be improved.

The separator 150 is a layer that insulates the positive electrode 120 from the negative electrode 130. The separator 150 is provided such that the positive electrode 120 and the negative electrode 130 are not in direct contact with each other, and is stacked between the positive electrode 120 and the negative electrode 130 in the electrode assembly. The material of the separator 150 is preferably electrically stable, chemically stable against the positive electrode active material, the negative electrode active material, and the electrolytic solution, and insulating. As the separator 150, for example, a layer made of a polymer nonwoven fabric, a porous film, glass, or ceramic fibers can be used. The material of the separator 150 more preferably includes a porous polyolefin film. The separator 150 may be composed of a plurality of layers, and a composite of a porous polyolefin film and a heat-resistant film containing fibers of polyimide, glass, or ceramics may be used.

An electrolyte is filled in a space surrounded by the insulating plate 118 and the battery can 111. The electrolyte contains an electrolyte salt and a solvent that dissolves the electrolyte salt. Examples of the electrolyte salt include lithium salts such as lithium perchlorate (LiClO₄), lithium hexafluorophosphate (LiPF₆), lithium tetrafluoroborate (LiBF₄), lithium bis(trifluoromethanesulfonyl)imide (LiN(SO₂CF₃)₂), lithium bis(pentafluoroethanesulfonyl)imide (LiN(SO₂C₂F₅)₂), and lithium hexafluoroarsenate (LiAsF₆). Examples of the solvent include nonaqueous solvents including lactone solvents such as γ-butyrolactone, γ-valerolactone, δ-valerolactone, and ε-caprolactone; carbonate ester solvents such as ethylene carbonate, propylene carbonate, butylene carbonate, vinylene carbonate, dimethyl carbonate, ethyl methyl carbonate, and diethyl carbonate; ether solvents such as 1,2-dimethoxyethane, 1-ethoxy-2-methoxyethane, 1,2-diethoxyethane, tetrahydrofuran, and 2-methyltetrahydrofuran; nitrile solvents such as acetonitrile; sulfolane solvents; phosphoric acids; phosphoric acid ester solvents; and pyrrolidones.

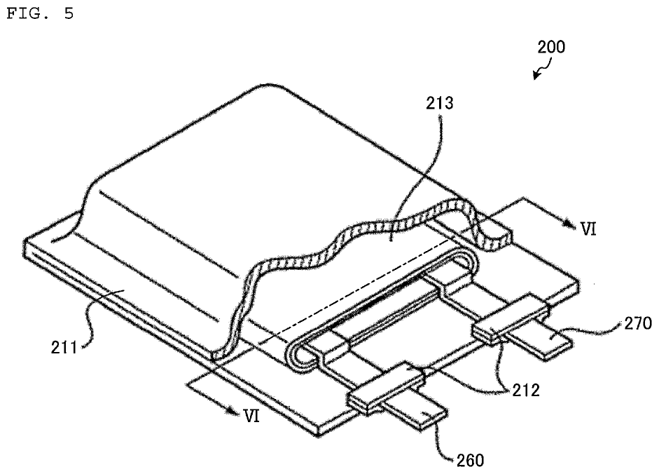

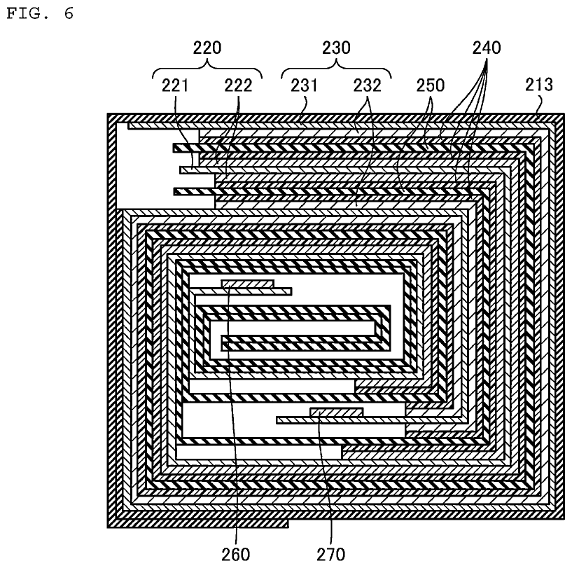

FIG. 5 is a cutaway view illustrating an example of a secondary battery according to a fourth embodiment. FIG. 6 is a schematic sectional view taken along line VI-VI in FIG. 5. The secondary battery 200 according to the fourth embodiment includes a gel-like electrolyte. As illustrated in FIGS. 5 and 6, the secondary battery 200 according to the fourth embodiment includes a battery element, an exterior member 211, an adhesive member 212, a protective member 213, a positive electrode 220, a negative electrode 230, a gel electrolyte layer 240, a separator 250, a positive electrode lead 260, and a negative electrode lead 270.

The exterior member 211 is a case of the secondary battery 200. The exterior member 211 includes an insulating layer, a metal layer, and an outermost layer. The exterior member 211 has a structure in which an insulating layer, a metal layer, and an outermost layer are stacked in this order from the inside and bonded by lamination processing or the like. The insulating layer of the exterior member 211 is made of, for example, a resin such as polyethylene, polypropylene, modified polyethylene, modified polypropylene, or a polyolefin resin containing ethylene or propylene as a monomer. This allows the exterior member 211 to lower the moisture permeability of the secondary battery 200, and improve the airtightness. The metal layer of the exterior member 211 is a plate material or a foil film made of metal such as aluminum, stainless steel, nickel, or iron. The outermost layer may be made of any material, but is preferably made of a material having high strength against breakage, piercing, or the like, such as a resin similar to the insulating layer or nylon.

The adhesive member 212 is a member for making the exterior member 211 airtight. The adhesive member 212 is provided each between the exterior member 211 and the positive electrode lead 260 and between the exterior member 211 and the negative electrode lead 270. The material of the adhesive member 212 preferably has adhesion to the positive electrode lead 260 and the negative electrode lead 270. For example, when the positive electrode lead 260 and the negative electrode lead 270 are metal, a polyolefin resin such as polyethylene, polypropylene, modified polyethylene, or modified polypropylene is used as the adhesive member 212. This allows for sealing of a gap between the exterior member 211 and the positive electrode lead 260 or the negative electrode lead 270, thereby making the exterior member 211 airtight.

The positive electrode 220 includes a positive electrode current collector layer 221 and a positive electrode active material layer 222. The material and thickness of the positive electrode current collector layer 221 are the same as those of the positive electrode current collector layer 21 in the first embodiment. The material and thickness of the positive electrode active material layer 222 are the same as those of the positive electrode active material layer 22 in the first embodiment.

The negative electrode 230 includes a negative electrode current collector layer 231 and a negative electrode material layer 232. Here, the negative electrode current collector layer 231 is an example of the “negative electrode current collector”. The negative electrode current collector layer 131 includes an anti-peeling layer, a negative electrode active material layer, and a cap layer which are made of the same materials as those of the first embodiment. That is, the anti-peeling layer is an example of the “first layer”, and the cap layer is an example of the “second layer”. Here, the cap layer is a layer thinner than the anti-peeling layer. Similarly to the negative electrode material layer 232 in the third embodiment, the negative electrode material layer 232 is a stack in which an anti-peeling layer, a negative electrode active material layer, and a cap layer are stacked in this order from the negative electrode current collector layer 231 side. Thus, in a case where the negative electrode active material layer expands, since the anti-peeling layer is provided, it is possible to suppress peeling of the negative electrode material layer 132 from the negative electrode current collector layer 131. Also, in a case where the negative electrode active material layer is cracked due to expansion, since the cap layer is provided, it is possible to suppress deterioration of the negative electrode active material due to entry of the electrolyte gel into the crack. As a result, the cycle characteristics of the secondary battery 200 can be improved.

As illustrated in FIG. 6, the positive electrode 220, the negative electrode 230, the gel electrolyte layer 240, and the separator 250 have a structure in which they are wound around the positive electrode lead 260 and the negative electrode lead 270. The negative electrode current collector layer 231, the negative electrode material layer 232, the gel electrolyte layer 240, the separator 250, the gel electrolyte layer 240, the positive electrode active material layer 222, the positive electrode current collector layer 221, the positive electrode active material layer 222, the gel electrolyte layer 240, the separator 250, the gel electrolyte layer 240, and the negative electrode material layer 232 are stacked in this order from the outside, that is, from the protective member 213 side.

The gel electrolyte layer 240 is a layer serving as the electrolyte of the secondary battery 200. The gel electrolyte layer 240 is a gel layer made of a polymer compound that holds an electrolytic solution. As the polymer compound used as the gel of the gel electrolyte layer 240, any polymer compound can be used as long as it forms a gel by absorbing a solvent, and examples thereof include a fluorine-based polymer compound such as a copolymer of polyvinylidene fluoride or vinylidene fluoride and hexafluoropropylene, an ether-based polymer compound such as polyethylene oxide or a crosslinked body containing polyethylene oxide, and a polymer compound containing polyacrylonitrile, polypropylene oxide, or polymethyl methacrylate as a monomer. The polymer compound used as the gel of the gel electrolyte layer 240 is preferably a fluorine-based polymer compound, and more preferably a copolymer containing vinylidene fluoride and hexafluoropropylene as monomers. By using this material, stability against oxidation-reduction reaction can be improved. Here, the copolymer of the polymer compound used as the gel of the gel electrolyte layer 240 may further contain, as a monomer, a monoester of an unsaturated dibasic acid such as monomethyl maleic acid ester, a halogenated ethylene such as ethylene trifluoride chloride, a cyclic carbonate ester of an unsaturated compound such as vinylene carbonate, an epoxy group-containing acrylic vinyl monomer, or the like. In this case, the cycle characteristics can be improved.

The positive electrode lead 260 is a terminal extended from the positive electrode current collector layer 221 to the outside of the exterior member 211. That is, the positive electrode lead 260 is a terminal serving as a plus electrode of the secondary battery 200. In FIG. 6, the positive electrode lead 260 is provided near the center of a portion surrounded by the protective member 213. The material of the positive electrode lead 260 is the same as the material of the positive electrode lead 116 in the third embodiment.

The negative electrode lead 270 is a terminal extended from the negative electrode current collector layer 231 to the outside of the exterior member 211. That is, the negative electrode lead 270 is a terminal serving as a minus electrode of the secondary battery 200. In FIG. 6, the negative electrode lead 270 is provided near the center of the portion surrounded by the protective member 213. The material of the negative electrode lead 270 is the same as the material of the negative electrode lead 117 in the third embodiment.

The protective member 213 is a member that protects the secondary battery 200. The protective member 213 is provided so as to be wound around the negative electrode 230. The protective member 213 is, for example, an insulator tape.

Note that the embodiments described above are intended to facilitate understanding of the present disclosure, but not intended to construe the present disclosure in any limited way. The present disclosure may be modified/improved without departing from the spirit thereof, and the present disclosure includes equivalents thereof.

### Description of Reference Symbols

1, 1A: Secondary battery

10: Protective layer

20: Positive electrode

21: Positive electrode current collector layer

22: Positive electrode active material layer

30, 30A: Negative electrode

31: Negative electrode current collector layer

32: Anti-peeling layer

33, 33a to 33d: Negative electrode active material layer

34, 34a to 34d: Cap layer

40: Solid-state electrolyte layer

50: Insulating layer

60: Side surface reinforcing portion

100: Secondary battery

110: Casing

111: Battery can

112: Lid

113: Heat sensitive resistance element

114: Safety valve mechanism

115: Gasket

116: Positive electrode lead

117: Negative electrode lead

118: Insulating plate

119: Center pin

120: Positive electrode

121: Positive electrode current collector layer

122: Positive electrode active material layer

130: Negative electrode

131: Negative electrode current collector layer

132: Negative electrode material layer

150: Separator

200: Secondary battery

211: Exterior member

212: Adhesive member

213: Protective member

220: Positive electrode

221: Positive electrode current collector layer

222: Positive electrode active material layer

230: Negative electrode

231: Negative electrode current collector layer

232: Negative electrode material layer

240: Gel electrolyte layer

250: Separator

260: Positive electrode lead

270: Negative electrode lead

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A negative electrode comprising:
a negative electrode current collector;
a negative electrode active material layer;
a first layer provided between the negative electrode current collector and the negative electrode active material layer; and
a second layer provided on the negative electrode active material layer,
wherein the negative electrode current collector contains at least one or more of copper, nickel, and iron, the negative electrode active material layer contains silicon,
the first layer contains silicon, a metal element constituting the negative electrode current collector, and at least one or more of titanium, nickel, zinc, silver, iron, boron, indium, and germanium, and
the second layer contains silicon and at least one or more of titanium, nickel, zinc, silver, iron, boron, indium, and germanium.

2. The negative electrode according to claim 1, wherein an element constituting the first layer excluding silicon and a metal constituting the negative electrode current collector are same as an element constituting the second layer excluding silicon.

3. The negative electrode according to claim 2, wherein
the element constituting the first layer excluding silicon and the metal constituting the negative electrode current collector is titanium, and
the element constituting the second layer excluding silicon is titanium.

4. The negative electrode according to claim 1, wherein
a concentration of silicon contained on a negative electrode active material layer side of the first layer is higher than a concentration of silicon contained on a negative electrode current collector side of the first layer,
a concentration of the metal constituting the negative electrode current collector contained on the negative electrode current collector side of the first layer is higher than a concentration of the metal constituting the negative electrode current collector contained on the negative electrode active material layer side of the first layer, and
the second layer contains silicon throughout a thickness direction.

5. A secondary battery comprising: the negative electrode according to claim 1; a positive electrode; and an electrolyte.
